(19) United States
(12) Patent Application Publication
(10) Pub. No.: US 2009/0041455 A1
(43) Pub. Date: Feb. 12, 2009

(54) PASSIVE OPTICAL NETWORK SYSTEMS WITH LOOP DETECTION CAPABILITY AND METHODS FOR THE LOOP DETECTION

(76) Inventors: Jun SHI, San Jose, CA (US); Oing LIN, San Jose, CA (US)

Correspondence Address: IPSG, P.C., P.O. BOX 700640, SAN JOSE, CA, 95170, US

(21) Appl. No.: 11/934,691

(22) Filed: Nov. 2, 2007

Related U.S. Application Data
(60) Provisional application No. 60/864,131, filed on Nov. 2, 2006.

(51) Int. Cl. H04B 10/08

(52) U.S. Cl. 398/17

(57) ABSTRACT

A passive optical network (PON) system with loop detection capability is disclosed. The PON system may include an optical line terminal (OLT) and an optical network unit (ONU). The PON system may also include a prober residing in at least one of the OLT and the ONU. The prober may be configured to send a probe frame through a port in the PON system. The probe frame may include at least a logical identifier of the port. Existence of a loop going through the port may be determined based on at least one of a first condition and a second condition. The first condition may represent that the probe frame returns to the prober at least once. The second condition may represent that the probe frame is received by the port at least twice.

The present invention claims priority under 35 USC 119(e) to a commonly owned provisionally filed patent application entitled “LOOP DETECTION IN A PASSIVE OPTICAL NETWORK SYSTEM,” U.S. Application No. 60/864,131, Attorney Docket No. OBRB-P002P1, filed Nov. 2, 2006 by inventor Jun Shi, which is incorporated herein by reference.

### BACKGROUND OF THE INVENTION

In communication systems, optical access systems offer a potentially large bandwidth as compared with copper-based access systems. A broadband optical access system may be utilized, for example, to distribute a variety of broadband and narrowband communication services from a service provider's facility to a local distribution point and/or directly to the customer premises. These communication services may include telephony (e.g. POTS, VoIP, and VoATM), data (e.g. ISDN, and Ethernet), and/or video/audio (e.g. television, CATV, PPV, and VoD) services.

In point-to-multiple-point optical access systems, loops may exist to cause traffic congestion or even system crash, and therefore cause deterioration or even disruption of communication services. A passive optical network (PON) system, such as an Ethernet passive optical network (EPON) system, is typically a point-to-multiple-point system that may include one optical line terminal (OLT) coupled to multiple optical network units (ONUs) and may potentially include a loop. FIGS. 1A and 1B illustrate EPON systems that include a loop.

FIG. 1 illustrates an example EPON system 100 that includes a loop. EPON system 100 includes an OLT 120, a splitter 122, and ONUs 110 and 111. OLT 120 is coupled to splitter 122 through link 106. Splitter 122 is coupled to ONUs 110 and 111 through links 107 and 109, respectively. ONUs 110 and 111 are coupled through link 108. A loop may be formed by links 106, 107, 108, and 109.

OLT 120 may send data (in the format of optical signals) through link 106. In turn, splitter 122 may duplicate the data and send a first copy to ONU 110 through link 107 and a second copy to ONU 111 through link 109, respectively. Therefore, the data (also represented by the first copy) may go through a first looped route represented by links 106-107-108-109-106. The data (also represented by the second copy) may also go through a second looped route represented by links 106-109-108-107-106. As a result, the data (including copies of the data) may continue to go through the loop in infinite cycles and in two opposite directions to cause congestion or even crash of EPON system 100.

FIG. 2 illustrates an example EPON system 150 that includes a loop. As illustrated in the example of FIG. 2, given a link 104 that connects a port 134 and a port 136 of a hub 132, a loop represented by links 101-102-103-104-103-102-101 may be formed. Consequently, data that goes through the loop may cause congestion or even crash of EPON system 150.

As well known, the spanning tree protocol (STP) may be employed to detect existence of a loop in a network system, if the components of the network system support the STP. However, some network components in EPON systems such as some ONUs may not support the STP. Therefore, the STP may not be applicable in some EPON systems.

### SUMMARY

An embodiment of the present invention relates to a passive optical network (PON) system with loop detection capability. The PON system may include an optical line terminal (OLT) and an optical network unit (ONU). The PON system may also include a prober residing in at least one of the OLT and the ONU. The prober may be configured to send a probe frame through a port in the PON system. The probe frame may include at least a logical identifier of the port. Existence of a loop going through the port may be determined based on at least one of a first condition and a second condition. The first condition may represent that the probe frame returns to the prober at least once. The second condition may represent that the probe frame is received by the port at least twice.

The above summary relates to only one of the many embodiments of the invention disclosed herein and is not intended to limit the scope of the invention, which is set forth is the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements in which:

FIG. 1A illustrates a schematic representation of a first example EPON system that includes a loop.

FIG. 1B illustrates a schematic representation of a second example EPON system that includes a loop.

FIG. 2A illustrates a schematic representation of an EPON system that includes a prober configured to send a probe frame for detecting existence of a loop in accordance with one or more embodiments of the present invention.

FIG. 2B illustrates a format of the probe frame in accordance with one or more embodiments of the present invention.

FIG. 3A shows a state transition table that tabulates states of a protected port and events associated with operating a prober in a PON system in accordance with one or more embodiments of the present invention.

FIG. 3B illustrates a finite state machine that represents transitions of the states of the protected port in the events in accordance with one or more embodiments of the present invention.

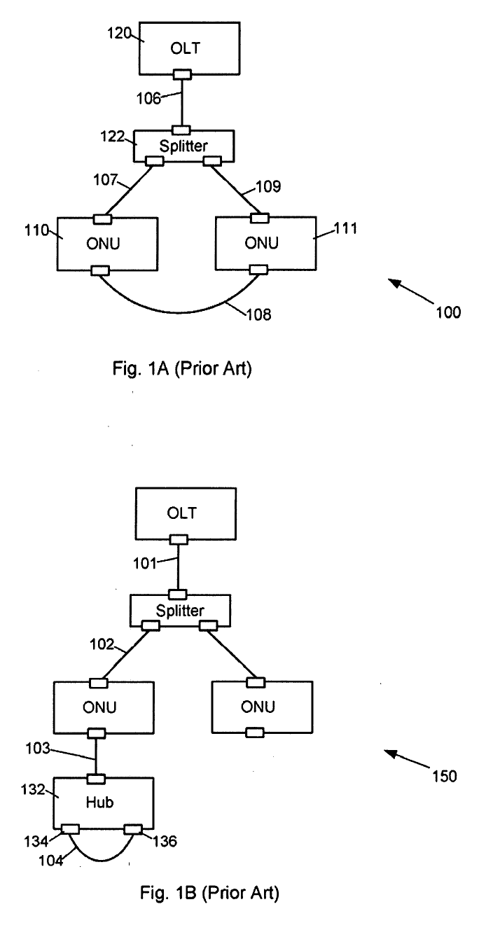

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

One or more embodiments of the invention relate to a passive optical network (PON) system with loop detection capability. The PON system may include an optical line terminal (OLT) and an optical network unit (ONU). The PON system may also include a prober residing in at least one of the OLT and the ONU. The prober may be configured to send a probe frame through a port in the PON system. The probe frame may include at least a logical identifier of the port. Existence of a loop going through the port may be determined based on at least one of a first condition and a second condition. The first condition may represent that the probe frame returns to the prober at least once. The second condition may represent that the probe frame is received by the port at least twice.

The prober may also be configured to close the port and/or a first set of ports in the loop if the loop is determined to exist. The PON system may also include a recovery timer configured to measure duration of a closure of the port. The prober may also be configured to reopen the port if a predetermined recovery time interval has elapsed and/or if the loop is removed.

The probe frame may include at least an Ethernet frame payload. The Ethernet frame payload may include at least the logical identifier of the port.

The PON system may also include a second prober configured to send a second probe frame through a second port in the PON system. The second probe frame may include at least a logical identifier of the second port. Existence of a second loop may be determined based on at least one of a third condition and a fourth condition. The second loop may represent a loop that goes through the second port. The third condition may represent that the second probe frame returns to the second prober at least once. The fourth condition may represent that the second probe frame is received by the second port at least twice.

One or more embodiments of the invention relate to a PON system. The PON system may include a first ONU including at least a first protected port. The PON system may also include a prober configured to periodically send a first set of probe frames to the first ONU. Each probe frame of the first set of probe frames may include a first Source Media Access Control (SMAC) address and a first Destination Media Access Control (DMAC) address. The first SMAC address may represent a Media Access Control (MAC) address of the first ONU. The first ONU may be configured to periodically send the first set of probe frames to a first set of ONUs, which may be specified by the first DMAC address. Existence of a loop going through the first protected port is determined based on at least one of a first condition and a second condition. The first condition may represent that at least one probe frame of the first set of probe frames returns to the prober at least once. The second condition may represent that one or more probe frames of the first set of probe frames are received by the first protected port at least twice.

In one or more embodiment, the first set of ONUs includes 64 ONUs; each of the 64 ONUs may include 2 ports. In one or more embodiments, the first set of ONUs may include one or more ONUs in a second PON system.

The PON system may also include a second GNU. The second ONU may include at least a second protected port. The prober may also be configured to periodically send a second set of probe frames to the second ONU. Each probe frame of the second set of probe frames may include a second SMAC address and a second DMAC address, the second SMAC address representing a MAC address of the second ONU. The second ONU may be configured to periodically send the second set of probe frames to a second set of ONUs, which may be specified by the second DMAC address. In one or more embodiments, the second set of ONUs may include one or more ONUs in the first set of ONUs.

The PON system may also include a probe timer configured to set a first time interval between sending two successive probe frames of the first set of probe frames. The probe timer may also be configured to set a second time interval between sending two successive probe frames of the second set of probe frames. In one or more embodiments, the probe timer may be implemented the prober.

One or more embodiments of the invention relate to a method for determine whether there exist one or more loops going through one or more ports in a PON system. The method may include sending, using a prober, a probe frame through a first port. The probe frame may include at least a logical identifier of the first port. The method may also include determining existence of a first loop based on at least one of a first condition and a second condition. The first loop may represent a loop that goes through the first port. The first condition may represent that the probe frame returns to the prober at least once. The second condition may represent that the probe frame is received by the first port at least twice.

The method may also include determining a time interval for the first port. The method may also include periodically sending probe frames to the first port.

The method may also include stopping sending further probe frames if the first loop is determined to exist. The method may also include starting a recovery timer for the first port if the first loop is determined to exist. The method may also include closing the first port if the first loop is determined to exist.

The method may also include clearing the recovery timer for the first port if the prober is disabled. The method may also include opening the first port if the prober is disabled.

The method may also include clearing the recovery timer for the first port if a predetermined recovery time interval has elapsed. The method may also include opening the first port if the predetermined recovery time interval has elapsed. The method may also include periodically sending additional probe frames to the first port after the predetermined recovery time interval has elapsed.

The method may also include periodically sending a set of probe frames from the prober to an ONU. The ONU may include at least a second port. Each probe frame of the set of probe frames may includes a SMAC address and a DMAC address. The SMAC address may represent a MAC address of the ONU. The method may also include periodically sending the set of probe frames from the ONU to a set of ONUs, the set of ONUs specified by the DMAC address. The method may also include determining existence of a second loop based on at least one of a third condition and a fourth condition. The second loop may represent a loop that goes through the second port. The third condition may represent that at least one probe frame of the set of probe frames returns to the prober at least once. The fourth condition may represent that one or more probe frames of the set of probe frames are received by the second port at least twice.

The features and advantages of the present invention may be better understood with reference to the figures and discussions that follow.

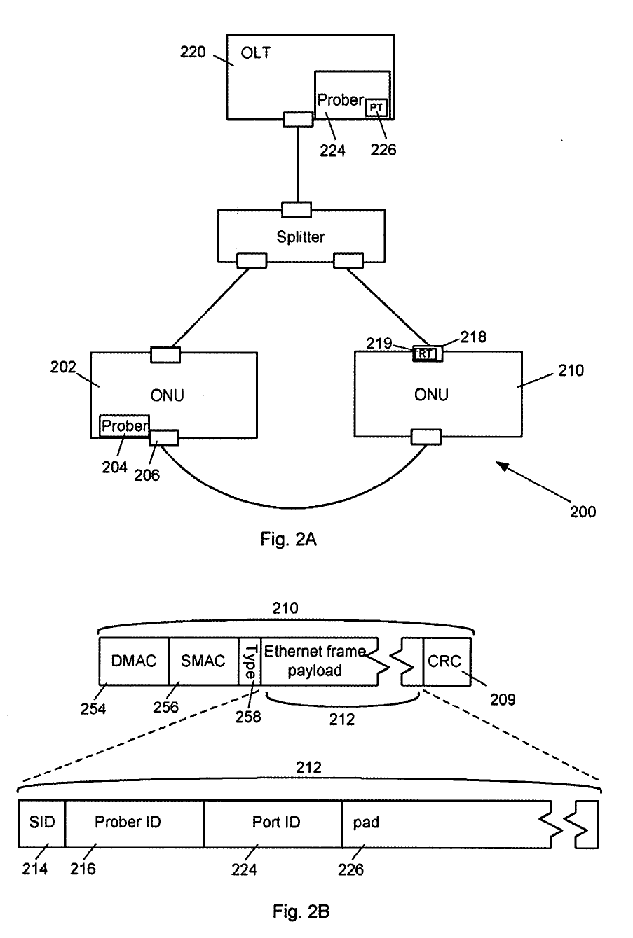

FIG. 2A illustrates, in accordance with one or more embodiments of the present invention, an EPON system 200 that includes a prober 224 for detecting existence of a loop in EPON system 200. Prober 224 may be a process or software application residing in OLT 220. Alternatively or additionally, EPON system 200 may include a prober 204 residing in ONU 202 for detecting existence of a loop in EPON system 200.

Prober 224 (and/or prober 204) may be configured to send a probe frame (for example, similar to probe frame 210 discussed below with reference to FIG. 2B) to a protected port 218 of ONU 210, for detecting existence of a loop that goes through protected port 218. In turn, protected port may send the probe frame to other ports in EPON system 200 (e.g., port 206). If the probe frame returns to prober 224 (and/or prober 204) at least once after some time, prober 224 (and/or prober 204) may determine that a loop going through protected port 218 exists. Alternatively or additionally, prober 224 (and/or prober 204) may determine the existence of the loop if protected port 218 has received the probe frame at least twice. Accordingly, prober 224 (and/or prober 204) may close protected port 218 and/or one or more other related ports (a set of ports in the loop) to prevent EPON system 200 from traffic congestion and/or crash. Closing a port means disable the port from transmitting and receiving traffic.

Prober 224 (and/or prober 204) may also be configured to periodically send probe frames to protected port 218. In one or more embodiments, prober 224 (and/or prober 204) may periodically a second set of probe frame to a second protected port (e.g., port 206) for detecting existence of a loop that goes through the second port.

EPON system 200 may include a probe timer 226 for configuring probe timer intervals for periodically sending probe frames. In one or more embodiments, probe timer 226 may be implemented in Prober 224 (and/or prober 204). A probe timer interval may represent a time interval between sending two successive probe frames. A probe timer interval may be individually configured for each individual protected port. Different protected ports may have different probe timer intervals.

EPON system 200 may include a recovery timer configured to measure the duration for which a protected port, such as protected port 218, has been closed. In one or more embodiments, a recovery timer 219 may be implemented in protected port 218 to measure a closure time of protected port 218. Alternatively or additionally, a recovery timer may be implemented in OLT 220. Prober 224 (and/or prober 204) may include logic to determine whether a predetermined recovery time interval has elapsed (or expired). Prober 224 (and/or prober 204) may reopen the protected port if a predetermined recovery time interval has elapsed. The recovery time interval may be configured at Prober 224 (and/or prober 204). Prober 224 (and/or prober 204) may also keep the protected port closed until the loop is removed and may reopen the protected port if the loop is removed.

FIG. 2B illustrates, in accordance with one or more embodiments of the present invention, a format of a probe frame 210, for example, sent by Prober 224 shown in the example of FIG. 2A. As illustrated in the example of FIG. 2B, probe frame 210 may include a destination MAC address 254 (DMAC 254), a source MAC address 256 (SMAC 256), a Type 258, an Ethernet frame payload 212, and a cyclic redundancy check 209 (CRC 209), described as follows.

DMAC 254 may represent a 48-bit (6 byte/6 octets) field that contains the MAC address of the station (e.g., an OLT or ONU) or stations (e.g., ONUs) to which an Ethernet frame payload 212 carried by probe frame 210 should be sent. Each station examines DMAC 254 to determine whether the station should accept Ethernet frame payload 212. As an example, the value of DMAC 254 may be 01-80-c2-00-00-xx. In one or more embodiments, DMAC 254 may represent a group MAC address that probe frame 210 is to be multicast.

SMAC 256 may represent a 48-bit (6 byte/6 octets) field that contains the unique MAC address of the station that is transmitting Ethernet frame payload 212. In one or more embodiments, SMAC 256 may represent the MAC address of an ONU that includes a protected port.

For example, SMAC 256 may contain the MAC address of ONU 210 (shown in FIG. 2A), which includes port 218 that is to be protected. Further, DMAC 254 may contain the MAC address of ONU 202 (shown in FIG. 2A), which is in the same EPON system 200 as ONU 210. Prober 224 (running on OLT 220 and shown in FIG. 2A) may send probe frame 210 to ONU 210 according to SMAC 256. In turn, ONU 210 may send probe frame 210 to ONU 202 according to DMAC 254. If probe frame 210 returns to prober 224, then prober 224 may determine that there exists a loop that goes through ONU 210 and ONU 202, and accordingly prober 224 may close port 218.

Type 258 may represent a 16-bit (2 byte/2 octets) field that identifies the higher-level protocol associated with Ethernet frame payload 212. Type 258 may be interpreted at the data link level. In one or more embodiments, the value of Type 258 may be 9010.

Ethernet frame payload 212 may be a data field that contains 46 to 1500 bytes. Ethernet frame payload 212 may contain information received from Layer 3 (Network Layer). The information received from Layer 3 may be broken into frames of information of 46 to 1500 bytes by Layer 2. In one or more embodiments, Ethernet frame payload 212 may be configured to contain information for detecting loops as described below.

CRC 209 may represent a 32-bit (4 byte/4 octets) error checking field. CRC 209 may be generated based on the DMAC 254, Type 258, and Ethernet frame payload 212.

In one or more embodiments, Ethernet frame payload 212 may include one or more of SID 214, Prober ID 216, Port ID 224, and pad 226.

SID 214 may represent a 16-bit (2 byte/2 octets) field that contains a sequence identifier of probe frame 210. For example, if probe frame 210 is the first probe frame that is sent by a prober, for example, after a sequence reset or a start of probing, the value of SID may be 1. The next probe frame sent by the prober may have a SID value of 2, i.e., with an increment of 1 from the SID value of probe frame 210.

Prober ID 216 may represent a 48-bit (6 byte/6 octets) field that contains a logical identifier of the EPON system in which probe frame 210 is employed. For example, the logical identifier may present EPON system 200 shown in the example of FIG. 2A.

Port ID 224 may represent a 48-bit (6 byte/6 octets) field that contains a logical identifier of a protected port such as, for example, port 218 shown the example of FIG. 2A.

Pad 226 may represent a field with an arbitrary number of octets up to 60 octets. In one or more embodiments, pad 226 may include 32 or more octets, such that Ethernet frame payload 212 may contain 46 or more octets.

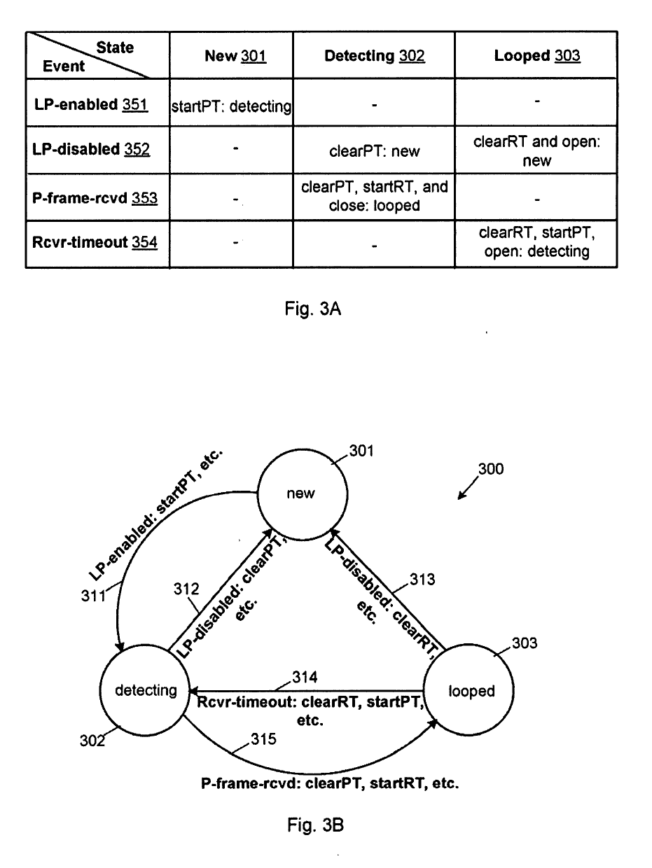

FIG. 3A shows, in accordance with one or more embodiments of the present invention, a state transition table that tabulates states of a protected port and events (or conditions) associated with operating a prober in a PON system. FIG. 3B shows, in accordance with one or more embodiments of the present invention, a finite state machine 300 that represents transitions of the states of the protected port in the events.

The states of the protected port may include a new state 301, a detecting state 301, and a looped state 303. New state 301 may represent the start state of the finite state machine shown in FIG. 3B. Detection state 302 may represent a state in which the protected port actively receives probe frames from the prober and sends the probe frames to other ONUs. Looped state 303 may represent a state in which the protected port is closed.

The events (or conditions) may include a loop-protection-enabled event 351, a loop-protection-disabled event 352, a probe-frame-received event 353, and a recovery-timeout event 354.

Loop-protection-enabled event 351 may represent a condition in which, for example, the prober periodically sends probe frames to the protected port, and the protected port is up physically and opened administratively for receiving and transmitting data packets.

Loop-protection-disabled event 352 may represent a condition in which, for example, the protected port is down physically or closed administratively, or the prober is manually disabled (e.g., by an administrator of the PON system) from sending probe frames.

Probe-frame-received event 353 may represent a condition in which, for example, the protected port receives a probe frame that has been sent by the protected port, or the prober receives a probe frame that has been sent by the prober.

Recovery-timeout event 354 may represent a condition in which, for example, a recovery time interval has expired (or elapsed).

The prober may take various actions according to the states of the protected port and the events. The actions may cause the protected port to enter different states.

When the protected port is in new state 301, in loop-protection-enabled event 351, the prober may execute action 311. Action 311 may represent determining a time interval for the protected port, starting a probe timer for the protected port, and periodically sending probe frames to the protected port according to the time interval, and therefore causing the protected port to enter detecting state 302.

When the protected port is in detecting state 302, in loop-protection-disabled event 352, the prober may execute action 312. Action 312 may represent clearing the prober timer for the protected port and stopping sending probe frames to the protected port, and therefore causing the protected port to enter new state 301.

Further, when the protected port is in detecting state 302, in probe-frame-received event 353, the prober may execute action 315. Action 315 may represent clearing the prober timer for the protected port, stopping sending probe frames to the protected port, starting a recovery timer for the protected port, and closing the protected port, therefore causing the protected port to enter loop state 303.

When the protected port is in looped state 303, in loop-protection-disabled event 352, the prober may execute action 313. Action 313 may represent clearing the recovery timer for the protected port and opening the protected port, and therefore causing the protected port to enter new state 301.

Further, when the protected port is in looped state 303, in recovery-timeout event 354, the prober may execute action 314. Action 314 may represent clearing the recovery timer for the protected port, opening the protected port, starting the probe timer for the protected port, and periodically sending probe frames to the protected port, and therefore causing the protected port to enter detecting state 302.

A PON system may operate multiple finite state machines that are similar to finite state machine 300 for detecting and/or protecting multiple ports. The multiple finite state machines may be operated by one or more probers.

As can be appreciated from the foregoing, embodiments of the invention may effectively detect loops in PON systems, thereby preventing traffic congestion and system crash potentially caused by loops. One or more embodiments of the invention may provide a data link layer (layer 2) protocol that is natural to an EPON system for detecting loops. Advantageously, loop detection may be readily implemented by one of ordinary skill in the art without significantly incurring additional overhead in the EPON system.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A passive optical network (PON) system comprising:
an optical line terminal (OLT);
an optical network unit (ONU); and
a prober residing in at least one of the OLT and the ONU, the prober configured to send a probe frame through a port in the PON system, the probe frame including at least a logical identifier of the port,
wherein existence of a loop going through the port is determined based on at least one of a first condition and a second condition, the first condition representing that the probe frame returns to the prober at least once, the second condition representing that the probe frame is received by the port at least twice.

2. The PON system of 1 wherein the loop is determined to exist if the probe frame returns to the prober at least once.

3. The PON system of 1 wherein the loop is determined to exist if the probe frame is received by the port at least twice.

4. The PON system of 1 wherein the prober is further configured to close at least one of the port and a first set of ports in the loop if the loop is determined to exist.

5. The PON system of 4 wherein the prober is further configured to reopen the port if a predetermined recovery time interval has elapsed.

6. The PON system of 4 wherein the prober is further configured to reopen the port if the loop is removed.

7. The PON system of 1 further comprising a recovery timer configured to measure duration of a closure of the port.

8. The PON system of 1 wherein the probe frame includes at least an Ethernet frame payload, the Ethernet frame payload including at least the logical identifier of the port.

9. The PON system of 1 further comprising a second prober configured to send a second probe frame through a second port in the PON system, the second probe frame including at least a logical identifier of the second port, wherein existence of a second loop is determined based on at least one of a third condition and a fourth condition, the second loop going through the second port, the third condition representing that the second probe frame returns to the second prober at least once, the fourth condition representing that the second probe frame is received by the second port at least twice.

10. A passive optical network (PON) system comprising:
a first optical network unit (ONU) including at least a first protected port; and
a prober configured to periodically send a first set of probe frames to the first ONU, each probe frame of the first set of probe frames includes a first Source Media Access Control (SMAC) address and a first Destination Media Access Control (DMAC) address, the first SMAC address representing a Media Access Control (MAC) address of the first ONU,
wherein the first ONU is configured to periodically send the first set of probe frames to a first set of ONUs, the first set of ONUs specified by the first DMAC address, and
existence of a loop going through the first protected port is determined based on at least one of a first condition and a second condition, the first condition representing that at least one probe frame of the first set of probe frames returns to the prober at least once, the second condition representing that one or more probe frames of the first set of probe frames are received by the first protected port at least twice.

11. The PON system of 10 wherein the first set of ONUs includes one or more ONUs in a second PON system.

12. The PON system of 10 further comprising a second ONU, the second ONU including at least a second protected port,
wherein the prober is further configured to periodically send a second set of probe frames to the second ONU, each probe frame of the second set of probe frames includes a second SMAC address and a second DMAC address, the second SMAC address representing a MAC address of the second ONU, and
the second ONU is configured to periodically send the second set of probe frames to a second set of ONUs, the second set of ONUs specified by the second DMAC address.

13. The PON system of 12 wherein the second set of ONUs includes one or more ONUs in the first set of ONUs.

14. The PON system of 12 further comprising a probe timer configured to set a first time interval between sending two successive probe frames of the first set of probe frames, the probe timer further configured to set a second time interval between sending two successive probe frames of the second set of probe frames.

15. The PON system of 14 wherein the probe timer is implemented the prober.

16. A method for determine whether there exist one or more loops going through one or more ports in a passive optical network (PON) system, the method comprising:
sending, using a prober, a probe frame through a first port, the probe frame including at least a logical identifier of the first port; and
determining existence of a first loop based on at least one of a first condition and a second condition, the first loop going through the first port, the first condition representing that the probe frame returns to the prober at least once, the second condition representing that the probe frame is received by the first port at least twice.

17. The method of 16 further comprising:
determining a time interval for the first port; and
periodically sending probe frames to the first port.

18. The method of 16 further comprising:
stopping sending further probe frames if the first loop is determined to exist;
starting a recovery timer for the first port if the first loop is determined to exist; and
closing the first port if the first loop is determined to exist.

19. The method of 18 further comprising:
clearing the recovery timer for the first port if the prober is disabled; and
opening the first port if the prober is disabled.

20. The method of 18 further comprising:
clearing the recovery timer for the first port if a predetermined recovery time interval has elapsed;
opening the first port if the predetermined recovery time interval has elapsed; and
periodically sending additional probe frames to the first port after the predetermined recovery time interval has elapsed.

21. The method of 16 further comprising:
periodically sending a set of probe frames from the prober to an optical network unit (ONU), the ONU including at least a second port, each probe frame of the set of probe frames includes a Source Media Access Control (SMAC) address and a Destination Media Access Control (DMAC) address, the SMAC address representing a Media Access Control (MAC) address of the ONU; periodically sending the set of probe frames from the ONU to a set of ONUs, the set of ONUs specified by the DMAC address; and
determining existence of a second loop based on at least one of a third condition and a fourth condition, the second loop going through the second port, the third condition representing that at least one probe frame of the set of probe frames returns to the prober at least once, the fourth condition representing that one or more probe frames of the set of probe frames are received by the second port at least twice.
